(19) United States
(12) Patent Application Publication
(10) Pub. No.: US 2026/0253957 A1
(43) Pub. Date: Aug. 27, 2026

(54) NON-AQUEOUS ELECTROLYTE

(71) Applicant: Northvolt AB, Stockholm (SE)

(72) Inventor: Joohwan KOH, Stockholm (SE)

(21) Appl. No.: 19/160,221

(22) PCT Filed: Feb. 26, 2024
(86) PCT No.: PCT/EP2024/054836

§ 371 Date: Aug. 27, 2025

(30) Foreign Application Priority Data
Feb. 28, 2023 (SE) 2350221-4

(51) Int. Cl. H01M 10/0568; H01M 4/02; H01M 4/36; H01M 4/38; H01M 4/525; H01M 4/583; H01M 10/0525; H01M 10/0567; H01M 50/431; H01M 50/449

(52) U.S. Cl. CPC H01M 10/0568; H01M 4/364; H01M 4/386; H01M 4/525; H01M 4/583; H01M 10/0525; H01M 10/0567; H01M 50/431; H01M 50/449; H01M 2004/027; H01M 2004/028

(57) ABSTRACT

The disclosure is related to a non-aqueous electrolyte for a lithium-ion battery cell comprising alkyl propionate and a lithium salt according to formula (I) where b is the charge of the lithium salt anion, preferably b=1, m is a number from 1 to 4, preferably m is a number from 1 to 2, n is a number from 0 to 8, optionally n is a number from 0 to 4, optionally n is a number from 1 to 8, optionally n is a number from 1 to 4, q is 0 or 1, M is B or P, R¹ is a C₁-C₁₀ alkylene group, C₄-C₂₀ arylene group or a halogenated form of these groups, optionally with other substituents and/or heteroatoms and/or form rings. R² is a halogen or a C₁-C₁₀ alkyl group, a C₄-C₂₀ arylene group, or a halogenated form of these groups, optionally with other substituents and/or heteroatoms and/or form rings, X¹ is O, S or NR⁴, wherein R⁴ is a halogen or an organic group. X² is O, S or NR⁴, wherein R⁴ is a halogen or an organic group. The disclosure is further related to a lithium-ion battery cell comprising the non-aqueous electrolyte.

### TECHNICAL FIELD

The present disclosure relates to a non-aqueous electrolyte for a lithium-ion battery cell and a lithium-ion battery cell.

### BACKGROUND ART

The use of rechargeable (secondary) batteries is becoming increasingly prevalent, due in part to trends in society such as vehicle electrification and pervasive use of mobile consumer electronics. Since their commercial introduction in 1991, lithium-ion batteries (Li-ion) batteries have been widely adopted in a variety of applications due to favourable properties such as high energy density, low self-discharge or little or no memory effect.

A Li-ion battery cell typically comprises a cathode and an anode, with an electrolyte and a separator arranged between the electrodes. Typically, the cathode comprises an intercalation material, which is a solid host network capable of reversibly storing lithium guest ions. Most commercialised cathode materials are based on transition metal oxides, such as the lithium cobalt oxide used in the first commercial lithium-ion batteries, although cathodes based on polyanion compounds such as lithium iron phosphate are now also commercially available. The anode typically comprises a carbon material such as graphitic or hard carbon, which is capable of intercalating lithium between its graphene planes. The separator may typically be a single- or multi-layer porous polyolefin membrane, sometimes coated with one or more ceramic layers. Electrolytes for lithium-ion batteries may typically be based on organic carbonates such as ethylene carbonate, with additives such as lithium salts used to optimise the electrolyte properties.

However, there remains a need to develop lithium-ion batteries with improved properties.

### SUMMARY

The inventors have identified a number of shortcomings with prior art lithium-ion batteries. In order to expand the range of applications to which Li-ion batteries are suited, there is a need to improve the cost and performance of the batteries. Some appropriate performance metrics that are desirable to be improved include, but are not limited to, charge rate, discharge rate, energy density, specific energy, power density, and specific power of the batteries. Some of the raw materials used in the manufacture of Li-ion batteries are relatively scare and thus expensive, particularly some of the transition metals used in cathode manufacture, and there is a desire to transition to the use of cheaper, more abundant materials.

In addition, the electrolyte, which is arranged in contact with the cathode and anode and plays a key role in transporting lithium ions between the anode and cathode, affects the performance of the lithium-ion battery in terms of e.g. impedance, cycle life and storage performance.

The present disclosure aims at providing an improved non-aqueous electrolyte which, when comprised in a lithium-ion battery cell, provides for a low impedance of the lithium-ion battery cell.

According to a first aspect, there is provided a non-aqueous electrolyte for a lithium-ion battery cell. The non-aqueous electrolyte comprises alkyl propionate and a lithium salt according to the following formula

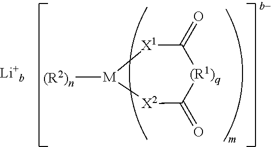

where b is the charge of the lithium salt anion, preferably b=1, m is a number from 1 to 4, preferably m is a number from 1 to 2, n is a number from 0 to 8, optionally n is a number from 0 to 4, optionally n is a number from 1 to 8, optionally n is a number from 1 to 4, q is 0 or 1, M is B or P, R¹ is a C₁-C₁₀ alkylene group, C₄-C₂₀ arylene group or a halogenated form of these groups, optionally with other substituents and/or heteroatoms and/or form rings. R² is a halogen or a C₁-C₁₀ alkyl group, a C₄-C₂₀ arylene group, or a halogenated form of these groups, optionally with other substituents and/or heteroatoms and/or form rings, X¹ is O, S or NR⁴, wherein R⁴ is a halogen or an organic group. X² is O, S or NR⁴, wherein R⁴ is a halogen or an organic group.

By the proposed non-aqueous electrolyte, the over-all impedance of the lithium-ion battery comprising the electrolyte is reduced. Typically the impedance of a lithium-ion battery cell comprising the proposed non-aqueous electrolyte is in the range of 0.20 mΩ to 80 mΩ.

By the proposed non-aqueous electrolyte the soaking ability, or wettability, of the non-aqueous electrolyte is increased due to the low viscosity of the alkyl propionate solvent. The improved soaking ability of the non-aqueous electrolyte provides for, when comprised in a lithium-ion battery cell, a lithium-ion battery cell having a low impedance since the increased soaking ability provides for an increased contact area between the electrodes and the electrolyte.

The improved soaking ability of the electrolyte further provides for a reduced production time and thus for a reduced production cost of a battery cell comprising the electrolyte since the time needed for filling the battery cell with electrolyte becomes shorter due to low viscosity of the electrolyte.

Moreover, the impedance of a battery cell comprising the non-aqueous electrolyte is further reduced by the P- or B-based oxalate. By phosphorus, P, or boron, B, the SEI layer as well as reactants comprising P or B becomes more efficient to stabilize the surface of the electrodes and suppress side reactions at the electrodes.

The lithium salt may further comprise lithium difluorobis(oxalato)phosphate, LiDFOP, lithium difluoro(oxalato)borate, LiDFOB, or lithium bis(oxalato)borate, LiBOB.

The proposed lithium salt, and in particular the fluorine of the proposed lithium salt, improves the stability of the additives, i.e. decreases the amount of undesired electrochemical reactions.

The lithium salt may comprise 0.01-1.0 wt % lithium difluorobis(oxalato)phosphate, lithium difluoro(oxalato)borate or lithium bis(oxalato)borate.

By the proposed concentration of the lithium salt, the impedance of the solid electrolyte interface, SEI, layer and cycle life of the battery cell is optimized. At concentrations above 1.0 wt %, the impedance of the solid electrolyte interface, SEI, typically becomes undesirably high.

The non-aqueous electrolyte may further comprise 0.01-1.5 mol/L LiPF₆.

When the non-aqueous electrolyte further comprises 0.01-1.5 mol/L LiPF₆, LiPF₆ is the main salt for the Li ion transport.

The non-aqueous electrolyte may comprise 0.01 to 20 wt % alkyl propionate.

Alkyl propionates have higher oxidation stability and lower melting points as compared to for example carbonate based solvents. Alkyl propionate does not provide for any electrochemical reactions upon normal cell operation voltages. By the proposed ratio of alkyl propionate, the battery cell performance is improved at high voltages, i.e. above 4.4 V, and temperatures, i.e. above 60° C. as compared to battery cells with electrolytes comprising carbonated based solvents.

The molar ratio of alkyl propionate to lithium difluorobis(oxalato)phosphate, lithium difluoro(oxalato)borate or lithium bis(oxalato)borate, LiBOB may be 1 to 20.

By the proposed molar ratio of alkyl propionate to lithium difluorobis(oxalato)phosphate, lithium difluoro(oxalato)borate or lithium bis(oxalato)borate, the oxidation stability and soaking ability of the electrolyte is improved.

The non-aqueous electrolyte may further comprise an additive, such as fluoroethylene carbonate or vinylene carbonate, wherein the additive has a reduction potential in the range of 0.01 to 1.5 V with respect to Li/Li⁺.

The proposed additives are electrochemically reduced at the surface of the anode during the first charging of the cell and creates a solid electrolyte interface, SEI, layer on the anode surface. The SEI layer prevents unfavourable side reactions between the solvent of the electrolyte and the electrode and thereby improves the cycle life of a lithium-ion battery cell comprising the non-aqueous electrolyte. The lithiation of the graphite of the anode occurs in a range 0.01 to 1.5 V, thus by a reduction potential in the range of 0.01 to 1.5 V with respect to Li/Li⁺, the additives react in the same voltage range.

The non-aqueous electrolyte may further comprise cesium bis(fluorosulfonyl)imide, CsFSI.

Cesium bis(fluorosulfonyl)imide, CsFSI is an additive which provides for formation of a lithium fluoride rich SEI layer on the anode surface. A lithium fluoride rich SEI layer provides for an increased ionic conductivity of the SEI layer which further reduces the lithium-ion battery cell impedance.

According to a second aspect, there is provided a lithium-ion battery cell comprising a cathode, an anode, a separator and the non-aqueous electrolyte.

The proposed lithium-ion battery cell comprises the non-aqueous electrolyte above and thus, provides the same advantages as the non-aqueous electrolyte above, i.e. a low impedance of the lithium-ion battery cell.

The cathode may comprise a cathode active material with the formula LiₓNiₐMn_{b}Co_{c}M_{d}O_{2-y}A_{y}, where 0.95<x<1.05, a+b+c+d=1, and 0.5≤a≤0.98, preferably 0.83≤a≤0.98, and where M is either absent or comprises one or more metal dopants, y≤0.1, and where A is one or more of S, N, F, Cl, Br, I, and P.

The above cathode active material, also known as nickel manganese cobalt, NMC, provides for an energy density comparable to lithium cobalt oxide (LCO) but to a lower cost. In particular, a high proportion of nickel of the NMC provides for a high energy/power density of the lithium-ion battery cell.

The anode may comprise Si, Si/C composite and/or SiOₓ, wherein 0<x<2.

By providing Si, Si/C composite and/or SiOₓ to the anode, the energy/power density of the lithium-ion battery cell is increased as compared to an anode not comprising Si, Si/C composite and/or SiOₓ.

The lithium-ion battery cell may further comprise an inorganic layer coated on the separator, wherein the inorganic layer comprises Al₂O₃, AlO(OH) and/or Al(OH)₃.

The inorganic layer acts as a heat shield and improves the safety of the lithium-ion battery cell by reducing the risk of the battery cell being overheated.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### DETAILED DESCRIPTION

A lithium-ion battery cell comprises at least one cathode assembly, at least one anode assembly, an electrolyte, and optionally a separator. The electrolyte is arranged in contact with the cathode and anode in order to provide ion transport within the cell. The separator, if present, is primarily intended to provide a physical barrier between the cathode and anode, whilst still permitting ion transport. The cell typically comprises a single cathode assembly and single anode assembly, but may comprise multiple cathodes, i.e. two or more cathodes, such as three, three or four cathodes, and/or multiple anodes, i.e. two or more anodes, such as three, four or five anodes. The contents of the cell may be housed in a casing. The cell may be of any design known in the art, such as a cylindrical, prismatic or pouch cell. The cell is preferably a cylindrical cell.

Depending on the application, single battery cells may be used, or the cells may be arranged into battery packs. A battery pack comprises a plurality of battery cells, i.e. two or more battery cells, such as from about two to about 20 000 cells, such as from about 10 to about 10 000 cells, such as from about 100 to about 1000 cells. A battery pack may comprise a plurality of cells arranged in series and/or parallel. A battery pack may comprise further components such as a battery management system and a pack housing to enclose the battery pack components.

A cathode assembly comprises a current collector and at least one cathode layer. The current collector may comprise, consist essentially of, or consist of a metal foil, such as an aluminium foil, a copper foil, a stainless steel foil, or combinations thereof. The current collector may preferably be aluminium foil. A cathode layer is arranged on at least one surface of the current collector, alternatively on both surfaces of the current collector. The cathode layer comprises cathode active material, binder, and optionally further additives such as conductive additive. The binder may be any binder known in the art, such as for example PVDF (polyvinylidene fluoride), SBR (styrene-butadiene rubber), CMC (carboxymethylcellulose), or combinations thereof. The binder preferably consists essentially of PVDF. The conductive additive may be for example a carbon material such as graphitic particles or graphite particles.

In one example, the cathode active material comprises of nickel manganese cobalt (NMC), LiₓNiₐMn_{b}Co_{c}MₐO_{2-y}A_{y}, where 0.95<x<1.05, a+b+c+d=1, and 0.5≤a≤0.98, preferably 0.83≤a≤0.98, and where M is either absent or comprises one or more metal dopants, y≤0.1, and where A is one or more of S, N, F, Cl, Br, I, and P.

NMC is among the most popular cathode materials for lithium-ion batteries, due in part to it having a specific energy comparable to lithium cobalt oxide (LCO) despite lower cost. The cathode active material may further comprise any cathode active material known in the art, including, but not limited to NMC, NCA, LCO, LMO, LFP, LMP and combinations thereof.

The cathode assembly may be prepared by coating the current collector with a slurry comprising the cathode active material, binder and optional additives in a suitable solvent. A suitable solvent may be a polar aprotic solvent such as NMP (N-methyl-2-pyrrolidone). Any suitable coating methods known in the art may be used. Following the coating, the cathode assembly may be further processed as is conventional in the art, such as by drying and calendaring.

An anode assembly comprises a current collector and at least one anode layer. The current collector may comprise, consist essentially of, or consist of a metal foil, such as a copper foil, an aluminium foil, a stainless steel foil, or combinations thereof. The current collector may preferably be copper. An anode layer is arranged on at least one surface of the current collector, alternatively on both surfaces of the current collector. The anode layer comprises anode active material, binder, and optionally further additives such as conductive additive. The binder may be any binder known in the art, such as for example SBR (styrene-butadiene rubber), CMC (carboxymethylcellulose), PVDF (polyvinylidene fluoride), or combinations thereof. The binder preferably consists essentially of a combination of SBR and CMC. The conductive additive may be for example a carbon material such as graphitic particles or graphite particles.

The anode active material may comprise, consist essentially of, or consist of any anode active material known in the art, including but not limited to graphite particles, graphitic carbon particles, amorphous carbon particles, silicon, silicon monoxide, germanium, tin, LTO (lithium titanium oxide), and combinations or composites thereof. The anode active material may consist essentially of graphite and/or graphitic particles, such as carbon-coated natural graphite particles, or secondary synthetic graphite particles. Alternatively, the anode active material may consist essentially of a composite of graphite and silicon monoxide. In one example, the anode comprises Si, Si/C composite and/or SiOx, wherein 0<x<2.

The anode assembly may be prepared by coating the current collector with a slurry comprising the anode active material, binder and optional additives in a suitable solvent. A suitable solvent may be a polar protic solvent such as water. Any suitable coating methods known in the art may be used. Following the coating, the anode assembly may be further processed as is conventional in the art, such as by drying and calendaring.

The electrolyte may comprise a solvent, a salt and optionally further additives. The salt may comprise a lithium salt soluble in the solvent at relevant concentrations. The electrolyte is arranged to dissociate the lithium salt and transport solvated lithium ions between the anode and the cathode of the lithium-ion battery cell. The electrolyte may be in liquid or solid form. The electrolyte disclosed herein is preferably in liquid form. Desirable properties of the electrolyte is high ionic conductivity, high electrochemical stability, high thermal stability and low cost.

The non-aqueous electrolyte of the present disclosure comprises alkyl propionate and a lithium salt according to the following formula

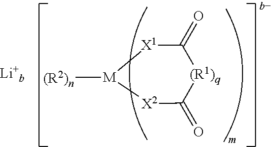

where b is the charge of the lithium salt anion, preferably b=1, m is a number from 1 to 4, preferably m is a number from 1 to 2, n is a number from 0 to 8, optionally n is a number from 0 to 4, optionally n is a number from 1 to 8, optionally n is a number from 1 to 4, q is 0 or 1, M is B or P, R¹ is a C₁-C₁₀ alkylene group, C₄-C₂₀ arylene group or a halogenated form of these groups, optionally with other substituents and/or heteroatoms and/or form rings, R² is a halogen or a C₁-C₁₀ alkyl group, a C₄-C₂₀ arylene group, or a halogenated form of these groups, optionally with other substituents and/or heteroatoms and/or form rings, X¹ is O, S or NR⁴, wherein R⁴ is a halogen or an organic group, and X² is O, S or NR⁴, wherein R⁴ is a halogen or an organic group.

By “non-aqueous” electrolyte is meant an electrolyte comprising a solvent which is other than water. The non-aqueous electrolyte of the present disclosure comprises alkyl propionate as solvent. By alkyl is meant as methyl, (—CH₃), ethyl, (—CH₂CH₃), propyl (—CH₂CH₂CH₃) etc. In one example, the solvent comprises a combination of two or more different alkyl propionates. The non-aqueous electrolyte may comprise 0.01 to 20 wt % alkyl propionate.

R¹ is a C₁-C₁₀ alkylene group, C₄-C₂₀ arylene group or a halogenated form of these groups, optionally with other substituents and/or heteroatoms and/or form rings.

R² is a halogen or a C₁-C₁₀ alkyl group, a C₄-C₂₀ arylene group, or a halogenated form of these groups, optionally with other substituents and/or heteroatoms and/or form rings.

By other substituents is meant an alkenyl group, an alkoxy group, a sulfonyl group, an amino group, a phosphonyl group, a cyano group, a carbonyl group, an acyl group, an amide group, an amine group or a hydroxy group.

By heteroatom is meant any atom which is not carbon or hydrogen that has replaced carbon in the backbone of the molecular structure. Examples of heteroatoms are nitrogen (N), oxygen (O), sulphur(S), phosphorus (P), chlorine (CI), bromine (Br), iodine (I), lithium (Li) or magnesium (Mg).

By form ring is meant a cyclic structure in which each every atom and bond is a member of a cycle. Preferably, the form ring comprises carbon atoms. Examples of form rings are pyridine, aryloxy group, arylsulfonated phosphine, arylphosphinite, arylphosphonite, arylphosphite, arylarsine, arylamine, arylsulfoxide, arylether and arylamide.

X¹ is O, S or NR⁴, wherein R⁴ is a halogen or an organic group, and X² is O, S or NR⁴, wherein R⁴ is a halogen or an organic group. By organic group is meant a C₁-C₁₀ alkyl group, a C₄-C₂₀ arylene group, or a halogenated form of these groups, optionally with other substituents and/or heteroatoms and/or form rings described in above.

In one example, the lithium salt comprises lithium difluorobis(oxalato)phosphate, LiDFOP, lithium difluoro(oxalato)borate, LiDFOB, or lithium bis(oxalato)borate, LiBOB. The lithium salt may comprise 0.01-1.0 wt % lithium difluorobis(oxalato)phosphate, lithium difluoro(oxalato)borate or lithium bis(oxalato)borate, LiBOB. The molar ratio of alkyl propionate to lithium difluorobis(oxalato)phosphate, lithium difluoro(oxalato)borate or lithium bis(oxalato)borate, LiBOB may be 1 to 20.

The non-aqueous electrolyte may further comprise at least one additive. The purpose of the at least one additive may be to stabilize the solvent/electrode interfaces, suppress gas formation, stabilize the cell against high voltage and overcharge, and/or decrease flammability. Such additives may be used in suitable concentrations.

In one example, the non-aqueous electrolyte of the present disclosure comprises an additive, such as fluoroethylene carbonate or vinylene carbonate. In yet an example, the non-aqueous electrolyte comprises cesium bis(fluorosulfonyl)imide, CsFSI. The non-aqueous electrolyte may comprise a combination of fluoroethylene carbonate or vinylene carbonate, and cesium bis(fluorosulfonyl)imide, CsFSI. The non-aqueous electrolyte may comprise CsFSI in the range of about 0.01 wt % to 5.0 wt %.

The battery cell may preferably comprise a separator arranged between the cathode assembly and the anode assembly. Any suitable separator known in the art may be used. The separator may comprise, consist essentially of, or consist of a porous polymer film. The polymer may be a polyolefin such as polyethylene (PE), polypropylene (PE), Polyvinylidene fluoride (PVDF), Polytetrafluoroethylene (PTFE), a polyester such as polyethylene terephthalate (PET), or a combination thereof. The separator may comprise a single layer or may be multi-layer, such as bilayer or trilayer. Further layers may comprise, consist essentially of, or consist of porous polymer films as described above, and/or may comprise, consist essentially of, or consist of ceramic material such as Al₂O₃, SiO₂, TiO₂, MgO, CaCO₃, and combinations thereof.

In one example, the battery cell may further comprise an inorganic layer coated on the separator. The inorganic layer may comprise Al₂O₃, AlO(OH) and/or Al(OH)₃. The inorganic layer may be arranged on separator at the anode side and/or on the separator at the cathode side.

### EXAMPLES

In Tables 1a-1b and 2a-2b below, experimental results of examples of lithium-ion battery cells comprising non-aqueous electrolyte are shown.

### Examples 1 and 2

Table 1a shows examples of lithium-ion battery cells comprising non-aqueous electrolyte comprising different concentrations of solvents and additives. Table 1b shows the cell performance of the examples shown in Table 1a.

Examples 1 and 2 and comparative examples 1 and 2 all relate to lithium-ion battery cells with an NMC cathode and a graphite anode having an operational voltage of 2.8 to 4.2 V. It should be noted that similar lithium-ion battery cell performance as shown in Table 1b is expected for an anode comprising a graphite/SiOₓ.

In all examples in Table 1a, the electrolyte comprises ethylene carbonate (EC), ethyl methyl carbonate (EMC) and dimethyl carbonate (DMC), and LiPF₆. In example 1 and example 2, the electrolyte further comprises an alkyl propionate, methyl propionate (MP), and ethyl propionate (EP), respectively.

All electrolyte examples comprise the additive vinylene carbonate, VC. In addition, in example 1, example 2 and comparative example 2, the electrolyte comprise LiDFOP. It should be noted that the lithium salt, lithium difluoro(oxalato)borate LiDFOP, is expressed as an additive in Table 1a below.

Table 1b shows the direct current impedance resistance, DCIR, measured during discharge mode of the lithium-ion battery cell for 10 seconds. As shown in Table 1b, the DCIR of the cell is decreased for Example 1 (comprising MP and LiDFOP) as compared to comparative example 1 (not comprising MP and LiDFOP) at a state of charge, SOC, of 50%, both at a temperature of 0° C. and at a temperature of 25° C. The same applies to example 2 (comprising EP and LiDFOP) and comparative example 2 (comprising LiDFOP but no EP).

Also the capacity retention, i.e. the remaining capacity after storage, at 300th cycle, both when stored in 25° C. and 45° C. is increased for example 1 as compared to comparative example 1, as well as for example 2 as compared to comparative example 2.

After storage of lithium-ion battery cells, the side reactions between the electrodes and the electrolyte typically are increased, resulting in an increase of the direct current impedance resistance, i.e. DCIR, of the lithium-ion battery cell. However, as noted in Table 1b, the DCIR growth is decreased for example 1 as compared to comparative example 1 after storage of the respective lithium-ion battery cells having a SOC of 100% for 4 weeks at 60° C. The same applies to example 2 when compared to comparative example 2.

As noted in Table 1b, the cell thickness increase after storage of the respective lithium-ion battery cells having a SOC of 100% for 4 weeks at 60° C. of both Example 1 and 2 is significantly reduced as compared to the cell thickness of the comparative examples, indicating fewer side reactions between the electrodes, in particular the cathode, and the electrolyte.

TABLE 1a
Lithium-ion battery cells, example 1 and 2 and comparative examples 1 and 2.
Lithium-ion battery cells, examples 1 and 2 and comparative examples 1 and 2

| | | | Voltage | Salt | | | | | | Additives | |
|---|---|---|---|---|---|---|---|---|---|---|---|
| | | | range | (mol/L) | Solvent (vol %) | | | | | (wt %) | |
| | Cathode | Anode | (V) | LiPF6 | EC | EMC | DMC | MP | EP | VC | LiDFOP |
| Comparative | NCM | Graphite | 2.8-4.2 | 1.3 | 20 | 40 | 40 | — | — | 1.0 | — |
| example 1 | | | | | | | | | | | |
| Comparative | NCM | Graphite | 2.8-4.2 | 1.3 | 20 | 40 | 40 | — | — | 1.0 | 1.0 |
| example 2 | | | | | | | | | | | |
| Example 1 | NCM | Graphite | 2.8-4.2 | 1.3 | 20 | 40 | 20 | 20 | — | 1.0 | 1.0 |
| Example 2 | NCM | Graphite | 2.8-4.2 | 1.3 | 20 | 20 | 40 | — | 20 | 1.0 | 1.0 |

TABLE 1b
Cell evaluation results, examples 1 and 2 and comparative examples 1 and 2.
Cell evaluation results, examples 1 and 2 and comparative examples 1 and 2

| | | | 25° C. | 45° C. | | | | |
|---|---|---|---|---|---|---|---|---|
| | 10 s discharge | | cycle life | cycle life | | | | |
| | mode, DCIR | | (1 C/1 C) | (1 C/1 C) | | | | |
| | (mOhm) | | Capacity | Capacity | 60° C. storage for 4 weeks (at SOC100) | | | |
| | 25° C. | 0° C. | retention | retention | Capacity | Capacity | DCIR | Cell |
| | at | at | at 300th | at 300th | retention | recovery | growth | thickness |
| | SOC50 | SOC50 | cycle | cycle | (%) | (%) | (%) | (%) |
| Comparative | 78.3 | 432.0 | 88.2 | 89.9 | 86.6 | 88.6 | 168.7 | 34.2 |
| Example 1 | | | | | | | | |
| Comparative | 79.8 | 440.1 | 89.0 | 91.2 | 88.0 | 90.0 | 165.4 | 26.4 |
| Example 2 | | | | | | | | |
| Example 1 | 71.3 | 393.4 | 91.2 | 93.8 | 87.8 | 91.8 | 147.7 | 22.4 |
| Example 2 | 72.1 | 397.4 | 93.9 | 95.6 | 88.0 | 92.7 | 145.6 | 21.1 |

In summary, a non-aqueous electrolyte comprising an alkyl propionate, such as MP or EP, and LiDFOB improves the performance of the cell by decreasing the impedance, improving the capacity retention and capacity recovery, reducing the DCIR growth and reducing the cell thickness increase after storage.

### Examples 3 and 4

Table 2a shows examples of lithium-ion battery cells comprising non-aqueous electrolyte comprising different concentrations of solvents and additives. Table 2b shows the cell performance of the examples shown in Table 2a.

Examples 3 and 4 and comparative examples 3 and 4 all relate to lithium-ion battery cells with an NMC cathode and a graphite anode having an operational voltage of 2.8 to 4.2 V. It should be noted that similar lithium-ion battery cell performance as shown in Table 2b is expected for an anode comprising graphite/SiOₓ.

In all examples in Table 2a, the electrolyte comprises ethylene carbonate (EC), ethyl methyl carbonate (EMC), dimethyl carbonate (DMC), and LiPF₆. In Example 3 and example 4, the electrolyte further comprises an alkyl propionate, methyl propionate (MP), and ethyl propionate (EP), respectively.

In all examples, the electrolyte comprises the additive vinylene carbonate (VC). In addition, in example 3, example 4 and comparative example 4, the electrolyte comprises the salt lithium difluoro(oxalato)borate, LiBOB. It should be noted that LiBOB is expressed as an additive in Table 2a below.

Table 2b shows the direct current impedance resistance, DCIR, measured during discharge mode of the lithium-ion battery cell for 10 seconds. As shown in Table 2b, the DCIR of the cell is decreased for example 3 (comprising MP and LiBOB) as compared to comparative example 3 (not comprising MP and LiBOB) at a state of charge, SOC, of 50%, both at a temperature of 0° C. and at a temperature of 25° C. The same applies to example 4 (comprising EP and LiBOB) and comparative example 4 (comprising LiBOB but no EP).

Also the capacity retention, i.e. the remaining capacity after storage, at 300th cycle, both when stored in 25° C. and 45° C. is increased for example 3 as compared to comparative example 3, as well for example 4 as compared to comparative example 4.

After storage of lithium-ion battery cells, the side reactions between the electrodes and the electrolyte typically are increased, resulting in an increase of the direct current impedance resistance, i.e. DCIR, of the lithium-ion battery cell. However, as noted in Table 2b, the DCIR growth is decreased for example 3 as compared to comparative example 3 after storage of the respective lithium-ion battery cells having a SOC of 100% for 4 weeks at 60° C. The same applies to example 4 when compared to comparative example 4.

As noted in Table 2b, the cell thickness increases after storage of the respective lithium-ion battery cells having a SOC of 100% for 4 weeks at 60° C. for both example 3 and 4 is significantly reduced as compared to the cell thickness of the comparative examples, indicating fewer side reactions between the electrodes, in particular the cathode, and the electrolyte.

TABLE 2a
Lithium-ion battery cells, example 3 and 4 and comparative examples 3 and 4.
Lithium-ion battery cells, examples 3 and 4 and comparative examples 3 and 4

| | | | Voltage | Salt | | | | | | Additives | |
|---|---|---|---|---|---|---|---|---|---|---|---|
| | | | range | (mol/L) | Solvents (vol %) | | | | | (wt %) | |
| | Cathode | Anode | (V) | LiPF6 | EC | EMC | DMC | MP | EP | FEC | LiBOB |
| Comparative | NCM | Graphite | 2.8-4.2 | 1.3 | 20 | 40 | 40 | — | — | 1.0 | — |
| example 3 | | | | | | | | | | | |
| Comparative | NCM | Graphite | 2.8-4.2 | 1.3 | 20 | 40 | 40 | — | — | 1.0 | 1.0 |
| example 4 | | | | | | | | | | | |
| Example 3 | NCM | Graphite | 2.8-4.2 | 1.3 | 20 | 40 | 20 | 20 | — | 1.0 | 1.0 |
| Example 4 | NCM | Graphite | 2.8-4.2 | 1.3 | 20 | 20 | 40 | — | 20 | 1.0 | 1.0 |

TABLE 2b
Cell evaluation results, examples 3 and 4 and comparative examples 3 and 4.
Cell evaluation results, examples 3 and 4 and comparative examples 3 and 4

| | 10 s discharge | | 25° C. cycle | 45° C. cycle | | | | |
|---|---|---|---|---|---|---|---|---|
| | mode, DCIR | | life (1 C/1 C) | life (1 C/1 C) | | | | |
| | (mOhm) | | Capacity | Capacity | 60° C. storage for 4 weeks (at SOC100) | | | |
| | 25° C. | 0° C. | retention | retention | Capacity | Capacity | DCIR | Cell |
| | at | at | at 300th | at 300th | retention | recovery | growth | thickness |
| | SOC50 | SOC50 | cycle | cycle | (%) | (%) | (%) | (%) |
| Comparative | 77.5 | 423.4 | 88.1 | 89.8 | 86.5 | 88.5 | 173.8 | 37.6 |
| Example 3 | | | | | | | | |
| Comparative | 79.8 | 440.3 | 90.8 | 93.4 | 88.2 | 92.9 | 159.9 | 33.9 |
| example 4 | | | | | | | | |
| Example 3 | 69.5 | 391.9 | 93.9 | 95.3 | 87.9 | 93.9 | 142.6 | 26.4 |
| Example 4 | 70.3 | 400.7 | 94.8 | 96.2 | 88.1 | 94.8 | 139.1 | 25.4 |

In summary, a non-aqueous electrolyte comprising an alkyl propionate, such as MP or EP, and LiBOB improves the performance of the cell by decreasing the impedance, improving the capacity retention and capacity recovery, reducing the DCIR growth and reducing the cell thickness increase after storage.

The person skilled in the art realizes that the present disclosure is not limited to the embodiments described above. The person skilled in the art further realizes that modifications and variations are possible within the scope of the appended claims. Additionally, variations to the disclosed embodiments can be understood and effected by the skilled person in practicing the claimed disclosure, from a study of the disclosure and the appended claims.

1. A non-aqueous electrolyte for a lithium-ion battery cell comprising alkyl propionate and a lithium salt according to the following formula 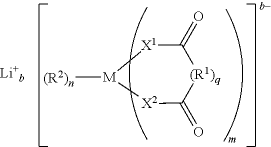
where b is the charge of the lithium salt anion, m is a number from 1 to 4, n is a number from 0 to 8, q is 0 or 1, M is B or P, R¹ is a C₁-C₁₀ alkylene group, C4-C20 arylene group or a halogenated form of these groups, with or without other substituents and/or heteroatoms and/or form rings, R² is a halogen or a C₁-C₁₀ alkyl group, a C₄-C₂₀ arylene group, or a halogenated form of these groups, with or without other substituents and/or heteroatoms and/or form rings, X¹ is O, S or NR⁴, wherein R⁴ is a halogen or an organic group, and X² is O, S or NR⁴, wherein R⁴ is a halogen or an organic group, wherein the substituents are chosen from the group consisting of an alkenyl group, an alkoxy group, a sulfonyl group, an amino group, a phosphonyl group, a cyano group, a carbonyl group, an acyl group, an amide group, an amine group or a hydroxy group, the heteroatoms are chosen from the group consisting of N, O, S, P, Cl, Br, I, Li or Mg, the form rings are chosen from the group consisting of pyridine, aryloxy group, arylsulfonated phosphine, arylphosphinite, arylphosphonite, arylphosphite, arylarsine, arylamine, arylsulfoxide, arylether and arylamide.

2. The non-aqueous electrolyte according to claim 1, wherein the lithium salt comprises lithium difluorobis(oxalato)phosphate, LiDFOP, lithium difluoro(oxalato)borate, LiDFOB, or lithium bis(oxalato)borate, LiBOB.

3. The non-aqueous electrolyte according to claim 2, wherein the lithium salt comprises 0.01-1.0 wt % lithium difluorobis(oxalato)phosphate, lithium difluoro(oxalato)borate or lithium bis(oxalato)borate.

4. The non-aqueous electrolyte according to claim 1, further comprising 0.01-1.5 mol/L LiPF₆.

5. The non-aqueous electrolyte according to claim 1, comprising 0.01 to 20 wt % alkyl propionate.

6. The non-aqueous electrolyte according to claim 1, wherein the molar ratio of alkyl propionate to lithium difluorobis(oxalato)phosphate, lithium difluoro(oxalato)borate or lithium bis(oxalato)borate is from 1 to 20.

7. The non-aqueous electrolyte according to claim 1, further comprising an additive, such as fluoroethylene carbonate or vinylene carbonate, wherein the additive has a reduction potential in the range of 0.01 to 1.5 V with respect to Li/Li⁺.

8. The non-aqueous electrolyte according to claim 1, further comprising cesium bis(fluorosulfonyl)imide, CsFSI.

9. A lithium-ion battery cell comprising a cathode, an anode, a separator and a non-aqueous electrolyte according to claim 1.

10. The lithium-ion battery cell according to claim 9, wherein the cathode comprises a cathode active material with the formula LiₓNiₐMn_{b}Co_{c}MₐO_{2-y}A_{y}, where 0.95<x<1.05, a+b+c+d=1, and 0.5≤a≤0.98, and where M is either absent or comprises one or more metal dopants, y≤0.1, and where A is one or more of S, N, F, Cl, Br, I, and P.

11. The lithium-ion battery cell according to claim 2, wherein the anode comprises Si, Si/C composite, and/or SiOx, wherein 0<x<2.

12. The lithium-ion battery cell according to claim 9, further comprising an inorganic layer coated on the separator, wherein the inorganic layer comprises Al₂O₃, AlO(OH) and/or Al(OH)₃.

13. The non-aqueous electrolyte according to claim 1, wherein m is a number from 1 to 2.

14. The non-aqueous electrolyte according to claim 1, wherein n is a number from 0 to 4.

15. The non-aqueous electrolyte according to claim 1, wherein n is a number from 1 to 8.

16. The non-aqueous electrolyte according to claim 1, wherein n is a number from 1 to 4.

17. The non-aqueous electrolyte according to claim 1, wherein b=1.

18. The lithium-ion battery cell according to claim 9, wherein 0.83≤a≤0.98.
